(19) United States
(12) Patent Application Publication
(10) Pub. No.: US 2005/0134913 A1
(43) Pub. Date: Jun. 23, 2005

(54) Printing system to request data for re-printing through a printing device

(76) Inventor: Jun-hyung Ha, Yongin-si (KR)

Correspondence Address: STANZIONE & KIM, LLP, 1740 N STREET, N.W., FIRST FLOOR, WASHINGTON, DC, 20036, US

(21) Appl. No.: 11/002,582

(22) Filed: Dec. 3, 2004

(30) Foreign Application Priority Data
Dec. 19, 2003 (KR) 2003-93591

(51) Int. Cl. G06F 15/00

(52) U.S. Cl. 358/1.15; 358/1.1

(57) ABSTRACT

A printing system and a printing method includes requesting re-transmission of once-printed data for re-printing through a printing device. The printing system has at least one printing device which includes a first interface unit to communication-interface with at least one host device transmitting printing data, an engine control unit to execute a printing job of the printing data received through the first interface unit, a memory to store information about the printing job executed by the engine control unit, a manipulation panel unit to display a list of the information about the printing job stored in the memory and to input a request for re-execution of the printing job, and a first control unit to detect the information about the printing job executed by the engine control unit and to store the information in the memory. The first control unit requests the corresponding host device to re-transmit the printing data through the first interface unit on receipt of the request for re-execution of the printing job through the manipulation panel unit. The information about the printing job stored in the memory includes at least one of a printing job ID, a host device ID and a file name.

### CROSS-REFERENCE TO RELATED APPLICATIONS

This application claims the benefit of Korean Patent Application No. 2003-93591, filed on Dec. 19, 2003, in the Korean Intellectual Property Office, the disclosure of which is incorporated herein in it entirety and by reference.

### BACKGROUND OF THE INVENTION

1. Field of the Invention

The present general inventive concept relates to a printing system and a printing method of printing data received from a plurality of hosts through a printing device. More particularly, the present general inventive concept relates to a printing system and a printing method of requesting re-transmission of once-printed data to re-print through a printing device.

2. Description of the Related Art

A printing system comprises at least one personal computer (PC) and at least one printer, which are connected to each other through a local area network (LAN) for transmission of data stored in the PC to the printer for printing. Such a printing system provides an advantage in that several users can share a limited resource effectively, so that the printing system becomes popular.

However, these printers carry out a printing job only in response to a printing command input through the PC. Therefore, if the printer and the PC are located considerably remote from each other, users experience inconvenience in going back to the PC to input a printing command and coming again to the printer to receive the printed output.

### SUMMARY OF THE INVENTION

In order to solve the foregoing and/or other problems, it is an aspect of the present general inventive concept is to provide a printing system having a printing device through which a user can directly request one-printed data to be re-printed, and a printing method thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a network printing system having at least one printing device which comprises a first interface unit to communication-interface with at least one host device transmitting printing data, an engine control unit to execute a printing job of the printing data received through the first interface unit, a memory to store information about the printing job executed by the engine control unit, a manipulation panel unit to display a list of the information about the printing job stored in the memory and to input a request for re-execution of the printing job, and a first control unit to detect the information about the printing job executed by the engine control unit and to store the information in the memory. The first control unit requests the corresponding host device to re-transmit the printing data through the first interface unit on receipt of a request for re-execution of the printing job through the manipulation panel unit.

In an aspect of the present general inventive concept, the information about the printing job stored in the memory may comprise at least one of a printing job ID, a host device ID and a file name.

In another aspect of the present general inventive concept, the host device may comprise a second interface unit connected with the first interface unit via a communication network to communication-interface with each other, a storage unit to store information about the printing data and the printing job which the host device requests the printing device and a second control unit to transmit the printing data stored in the storage unit to the printing device through the second interface unit according to a user's demand, to store the information about the executed printing job, and to re-transmit the printing data at the request of the printing device for the re-transmission of the printing data.

In yet another aspect of the present general inventive concept, the information about the printing job stored in the storage unit may comprise at leas one of a printing job ID, a printer ID, and a file name.

The foregoing and/or other aspects and advantages of the present general inventive concept may also be achieved by providing a printing method comprising printing data received from the host device according to a request from at least one host device for a printing job, storing in a memory information about the executed printing job and generating a list of the job information, requesting re-execution of the printing job, requesting the host device to re-transmit the printing data which was once printed, based on the information about the printing job, and receiving the printing data from the host device and re-printing the re-transmitted printing data.

The requesting of the re-execution of the printing job may comprise displaying the list of the information about the printing job according to a user's demand, and selecting one of the list of the job information about the printing job.

In an aspect of the present general inventive concept, the information about the printing job may comprise at least one of a printing job ID, a host ID, and a file name.

In another aspect of the present general inventive concept, the host device may be one of a desktop PC, a laptop PC, a PDA (Personal Digital Assistant), and a mobile phone, and the printing device may be a printer.

The foregoing and/or other aspects and advantages of the present general inventive concept may also be achieved by providing a printing system comprising_a printing device to receive printing data transmitted fro an external source, to print the printing data, to store information about the printing data and the external source, and to output a signal to request the external source to retransmit the print data, according to the information.

The foregoing and/or other aspects and advantages of the present general inventive concept may also be achieved by providing a printing system comprising_a computer to transmit printing data to an external printing device, to store information about the printing data and the external printing device, to receive from the external printing device a signal to retransmit the transmitted printing data, and to retransmit the printing data to the external printing device according to the signal and the information.

The foregoing and/or other aspects and advantages of the present general inventive concept may also be achieved by providing a printing system comprising an external source to generate printing data, and a printing device to receive printing data transmitted from the external source, to print the printing data, to store information about the printing data and the external source, and to output a signal to request the external source to retransmit the printing data, according to the information, so that the external source retransmits the printing data to the printing device according to the signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a network printing system according to an embodiment of the present general inventive concept;

FIG. 2 is a block diagram showing one of host PCs of FIG. 1;

FIG. 3 is a block diagram showing one of printers of FIG. 1;

FIGS. 4A and 4B are tables showing lists of printing job information stored in one host PC;

FIG. 5 is a table showing a list of printing job information stored in one printer;

FIGS. 6A and 6B are flowcharts showing a printing job execution method of a host PC according to another embodiment of the present general inventive concept; and

FIGS. 7A and 7B are flowcharts showing a printing job execution method of a printer according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

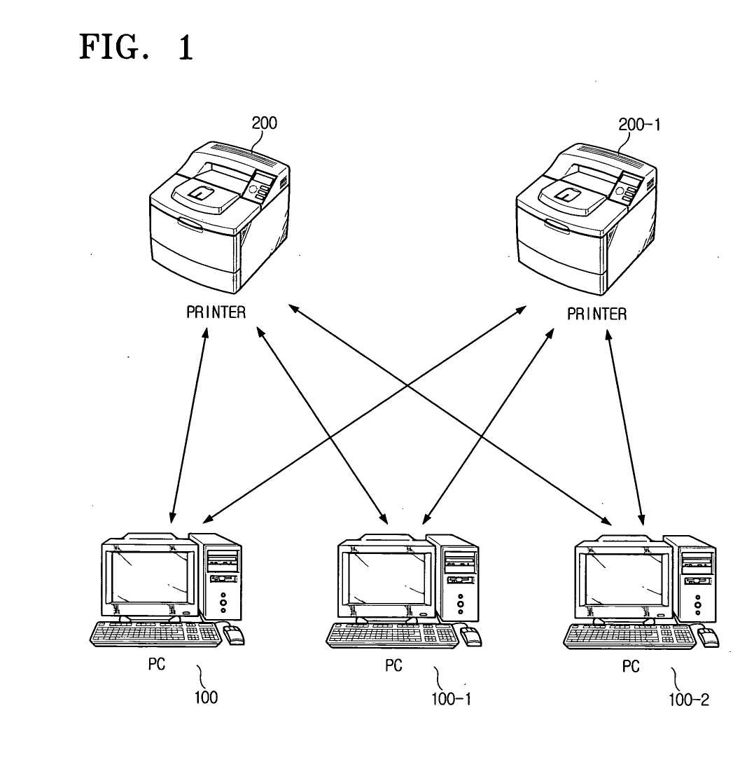

FIG. 1 is a view showing a network printing system according to an embodiment of the present general inventive concept. Referring to FIG.1, the printing system may comprise a plurality of personal computers (PCs) 100, 100-1, and 100-2 and a plurality of printers 200 and 200-1 connected to the PCs 100, 100-1, and 100-2.

The printers 200 and 200-1 can carry out printing jobs of printing print data in response to printing commands input through the PC 100, 100-1, and 100-2. When a printing command is input through the printers 200 and 200-1 with respect to the once-printed data, the printers 200, 200-1 can request their corresponding PCs to re-transmit the once-printed data to re-print and can receive the requested once-printed data from the corresponding PCs.

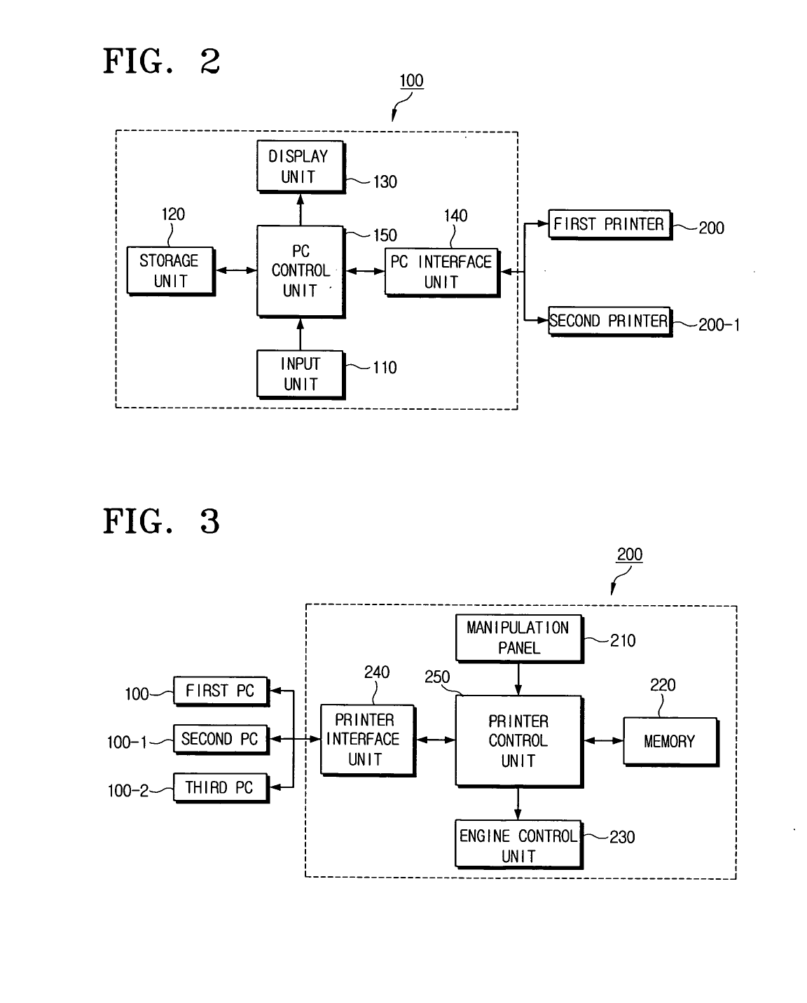

The first PC 100 of FIG. 1 will be representatively described below in detail with reference to FIGS. 1 and 2. However, if will be appreciated that the other PCs 100-1 and 100-2 are identical to the first PC 100.

Referring to FIG. 2, the first PC 100 may comprise an input unit 110, a storage unit 120, a display unit 130, a PC interface unit 140, and a PC control unit 150.

The input unit 110 can comprise a keyboard or a mouse through which a user command is inputted. The display unit 130 may comprise a monitor to display an operating state and an output of the first PC 100.

The storage unit 120 can comprise a hard disk (HD) to store therein applications executed in the first PC 100 and various printing data. More specifically, the storage unit 120 can also store therein information, such as a printing job execution application, a printing job management application, and information on a printer connected to the first PC 100.

The PC interface unit 140 can be accessible to the printers 200 and 200-1 and an external communication network (not shown) through a wire or wireless communication network ot a local area network, for data communication.

The PC control unit 150 can control overall operations of the first PC 100 and can execute the printing job management application (not shown) stored in the storage unit 130.

When a printing job command is inputted through the input unit 110, the PC controller unit 150 can read out data and can display the data on the display unit 130. Here, the printing job command is referred to as a command to request to print certain data through a certain selected printer. Then, the PC control unit 150 can transmit the read data to the selected printer through the PC interface unit 140 to execute the printing job.

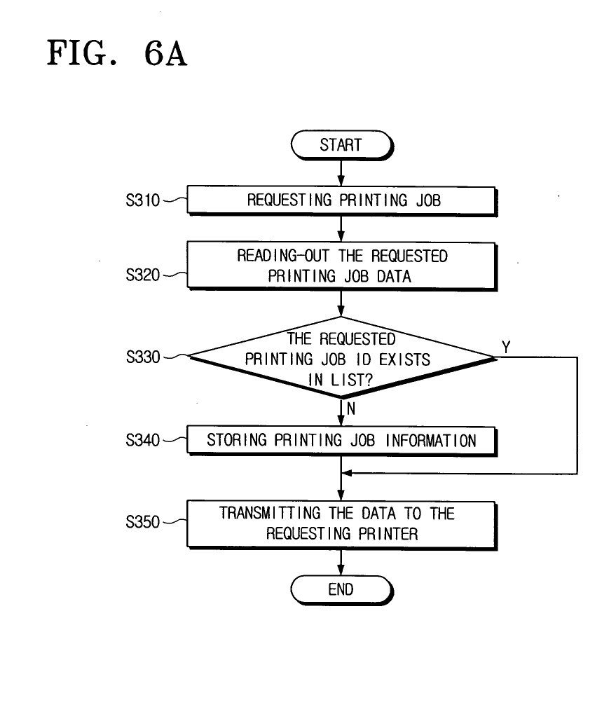

The PC control unit 150 can store in the storage unit 120 information about the requested printing job. The printing job information is tabulated as shown in FIG. 4A and 4B and stored in the storage unit 120. The stored printing job information may include three entries, such as a printing job list, a printer IP, and a file name.

Referring FIG. 4A, the printing job information stored in the first PC 100 may include JOB ID 1, JOB ID 2, and so on. The JOB ID 1 has a file name of “address.doc,” and the first printer 200 at IP 168.219.12.70 prints the data of the file “address.doc.” Also, the JOB ID 2 has a file name of “birthday party.jpg,” and the first printer 200 at IP 168.219.12.70 prints the data of the file “birthday party.jpg.”

Referring to FIG. 4B, the printing job information stored in the second PC 100-1 may include JOB ID 3, JOB ID 4 and so on. The JOB ID 3 has a file name of “report.doc,” and the first printer 200 at IP 168.219.12.70 prints the data of the file “report.doc.” Also, the JOB ID 4 has a file name of “presentation document.ppt,” and the second printer 200-1 at IP 168.219.15.70 prints the data of the file “presentation document.ppt.”

When the printer 200 requests the PC control unit 150 to re-transmit once-printed data, the PC control unit 150 can read out the once-printed data based on the printing job information list stored in the storage unit 29 and can re-transmit the data to the requesting printer 200.

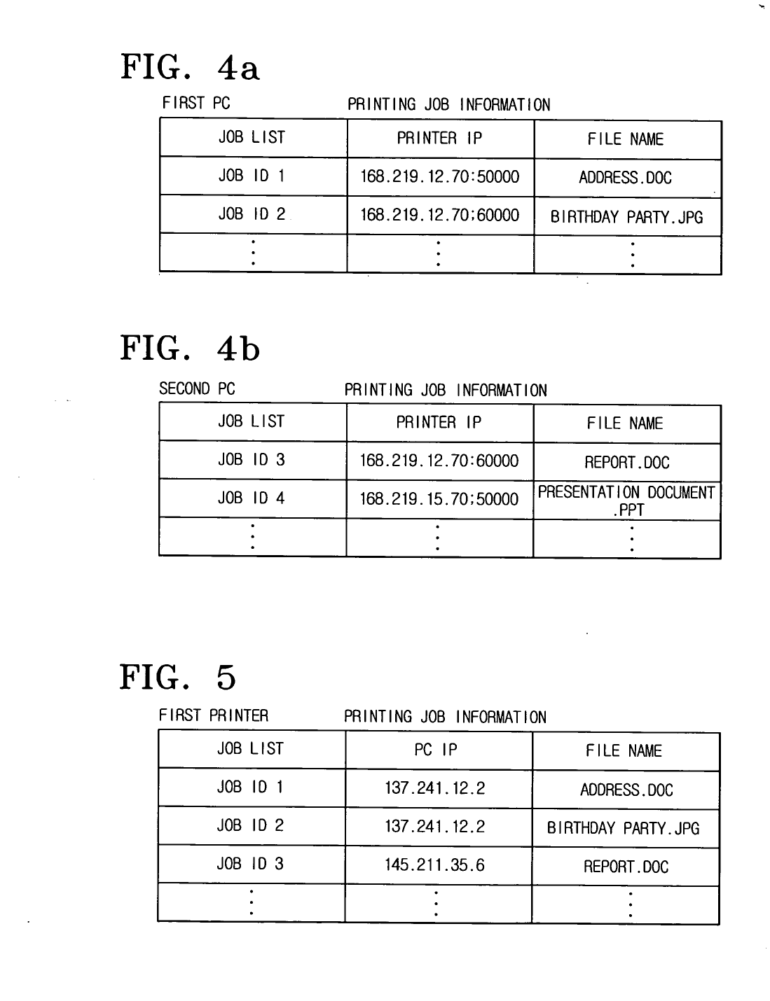

Hereinafter, the first printer 200 of FIG. 1 will be representatively described in detail with reference to FIGS. 2 and 3.

The first printer 200 can perform a printing job at the request of the PCs 100 and 100-1, and can request a corresponding PC to re-transmit of the once-printed data to be re-printed. The first printer 200 may comprise a manipulation panel 210, a memory 220, an engine control unit 230, a printer interface unit 240, and a printer control unit 250.

The manipulation panel 210 can be used for inputting a user's command and can display an operating state and a specific message of the printer 200. The manipulation panel 200 can be disposed on an upper or front portion of the printer 200. The manipulation panel 210 can be provided with a plurality of function keys (not shown) to set various functions supported by the printer 200 and also to set printing environments of the printer 200. A separate manipulation key to request the re-printing of data may be provided on the manipulation panel 210.

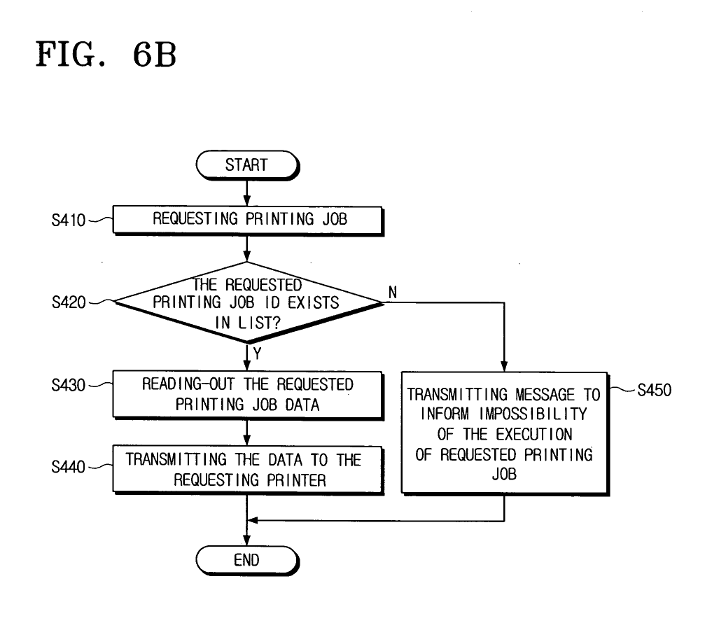

The memory 220 can temporarily store therein data received from the PCs 100, 100-1, and 100-2 prior to printing the data, and can especially store information about once-executed printing job. FIG. 5 shows one example of a list of the printing job information.

Referring to FIGS. 2 through 5, the printing job information stored in the first printer 200 may include JOB ID 1, JOB ID 2, JOB ID 3, and so on. The JOB ID 1 and JOB ID 2 respectively have file names of “address.doc” and “birthday party.jpg” which are transmitted from the first PC 100 at an IP 137.241.12.2. JOB ID 3 has a file name of “report.doc” which is transmitted from the second PC 100-1 at an IP 145.211.35.6.

For example, in order to re-print the data of “report.doc,” a user can select a printing job information display key provided on the manipulation panel 210, so that the printing job information list of FIG. 5 can be displayed on a screen. From the list of the printing job information, the user can select the JOB ID 3.

At a request for re-printing of the JOB ID 3, the printer control unit 250 can transmit to the second PC 100-1 a signal to request the re-transmission of the data of “report.doc” through the printer interface unit 240. In response to this signal, the second PC 100-1 can re-transmit the data to the printer control unit 250. The printer control unit 250 can control the engine control unit 230 to print the re-transmitted data.

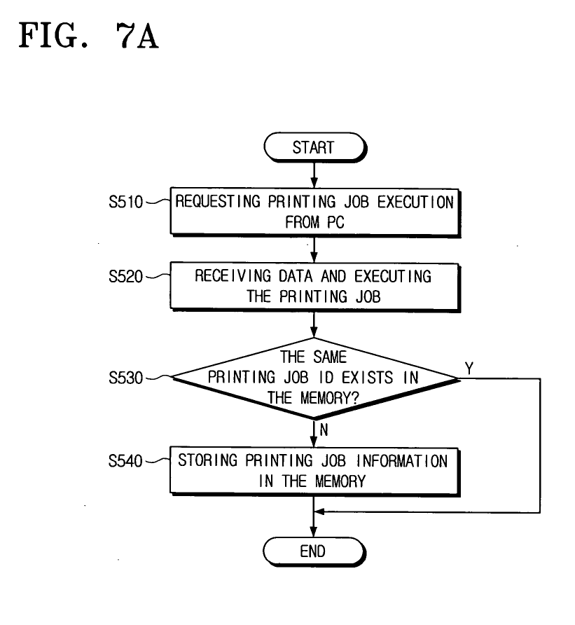

FIGS. 6A and 6B are flowcharts showing a printing job execution method of a host PC in a printing system according to another embodiment of the present general inventive concept.

Referring to FIG. 6A, data to be printed and a printer to print the data can be selected through the input unit 110 provided on the first PC 100, and a printing job execution can be requested in operation S310. The PC control unit 150 can read out the data in response to the printing job execution request in operation S320. Also, the PC control unit 150 can detect whether the requested printing job has been previously executed based on the printing job information list stored in the storage unit 120 in operation S330. If information about the requested printing job is not determined to exist in the printing job information list as a result of the detection, the information can be stored in the storage unit 120 in operation S340. The read data can be transmitted to the selected printer through the PC interface unit 140 in operation S350. Meanwhile, if the information about the requested printing job is determined to exist in the printing job information list in operation S330, the read data can be transmitted to the selected printer.

Referring to FIG. 6B, when one of printers connected to the first PC 100 requests the transmission of data a printing job in operation S410, the PC control unit 150 can detect whether the requested printing job has been previously executed based on the printing job information list of the storage unit 120 in operation S420. As a result of the detection, if the information about the requested printing job has been already stored in the storage unit 120, the data is read out based on the printing job information in operation S430. The read data can be transmitted to the printer through the PC interface unit 140 in operation S440. If the information about the requested printing job does not exist in the printing job information list in operation S420, a signal to inform the printer impossibility of the transmission of the requested data can be transmitted to the printer in operation S450.

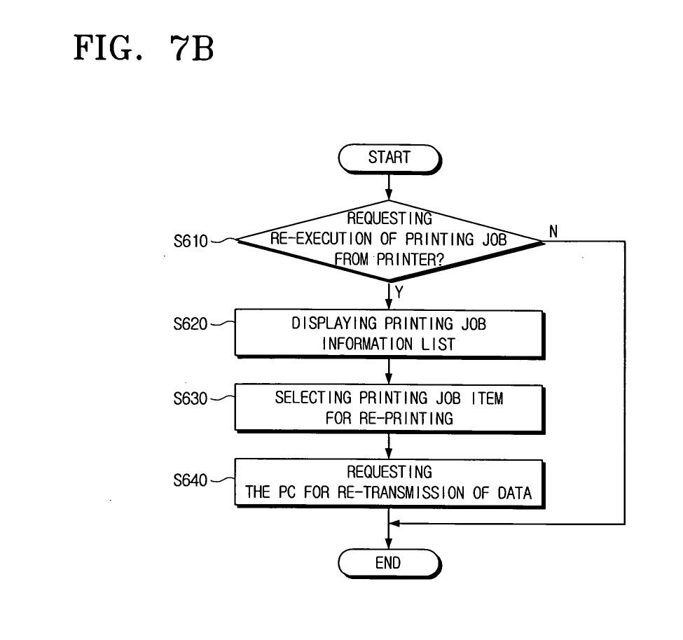

FIGS. 7A and 7B are flowcharts showing a printing job execution method of a printer, for example, the printer 200 of FIG. 1, in a printing system according to another embodiment of the present general inventive concept.

Referring to FIGS. 3 and 7A, when the printer 200 receives a request signal for the printing job with respect to certain data from the PC 100 connected thereto in operation S510, the printer control unit 250 can transmit a response signal to the PC 100, can receive the data from the PC 100 through the printer interface unit 240, and can execute the printing job by operating the engine control unit 230 in operation S520. The printer control unit 250 can detect whether the information about the executed printing job is stored in the memory 220 in operation S530. As a result of the detection, if the information about the executed printing job does not exist in the memory 220, the information can be stored in the memory 220 in operation S540.

Referring to FIGS. 3 and 7B, in order to re-print the once-printed data, a user can request the re-execution of the printing job through the manipulation panel 210 of the printer 200 in operation S610. Accordingly, the printer control unit 250 can read out the printing job information list from the memory 220 and can display the list on a screen provided on the manipulation panel 210 in operation S620. The user can select an item corresponding to a desired printing job to re-print using the function key of a manipulation panel 210 in operation S630. The printer control unit 250 can transmit to the PC, which has previously requested the printing of the selected printing job, a signal to request the re-transmission of the data based on the printing job information of the selected printing job in operation S640.

As described above, the printer of the printing system according to the present general inventive concept is capable of requesting a re-printing job with respect to the once-printed data by using the information about the printing job previously executed at the request of the printer and the PC of the printing system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A printing system comprising:
a printing device comprising,
a first interface unit to communication-interface with at least one host device transmitting printing data,
an engine control unit to execute a printing job of the printing data received through the first interface unit,
a memory to store information about the printing job executed by the engine control unit,
a manipulation panel unit to display a list including the information about the printing job stored in the memory and to input a request for re-execution of the printing job, and
a first control unit to detect the information about the printing job executed by the engine control unit, to store the information in the memory, and to request the corresponding host device to re-transmit the printing data through the first interface unit on receipt of the request for re-execution of the printing job through the manipulation panel unit according to the information.

2. The printing system of claim 1, wherein the information about the printing job stored in the memory comprises at least one of a printing job ID, a host device ID, and a file name of the printing data.

3. The printing system of claim 1, wherein the host device comprises:
a second interface unit connected with the first interface unit via a communication network to communication-interface with the printing device;
a storage unit to store information about the printing data and the printing job which the host device requests the printing device; and
a second control unit to transmit the printing data stored in the storage unit to the printing device through the second interface unit, to store the information about the executed printing job, and to re-transmit the printing data at the request of the printing device.

4. The printing system of claim 3, wherein the information about the printing job stored in the storage unit comprises at least one of a printing job ID, a printer ID, and a file name of the printing data.

5. A printing system comprising:
a printing device to receive printing data transmitted from an external source, to print the printing data, to store information about the printing data and the external source, and to output a signal to request the external source to re-transmit the printed print data, according to the information.

6. The printing system of claim 5, wherein the printing device executes a first printing job to print the transmitted printing data from the external source and re-executes the first printing job as a second printing job to print the re-transmitted printing data from the external source.

7. The printing system of claim 5, wherein the printing device is connected to the external source through a wire or wireless communication network or a local area network.

8. The printing system of claim 5, wherein the printing device receives second printing data transmitted from a second external source, print the second printing data, stores second information about the second printing data and the second external source, and to output a second signal to request the second external source to re-transmit the second printing data, according to the second information.

9. The printing system of claim 8, wherein the printing device executes a first printing job to print the transmitted printing data from the external source, re-executes the first printing job as a second printing job to print the re-transmitted printing data, executes a third printing job to print the transmitted second printing data from the second external source, and re-executes the third printing job as a fourth printing job to print the re-transmitted second printing data.

10. The printing system of claim 8, wherein the printing device is connected to the external source and the second external source through a wire or wireless communication network or a local area network.

11. The printing system of claim 5, wherein the information comprises second printed printing data received from a second external source, and the printing device outputs the signal to request the external source to re-transmit one of the printed printing data and the second printed printing data, according to a user selection.

12. The printing system of claim 5, wherein the printing device comprises a display to display the information.

13. The printing system of claim 5, wherein the information comprises an IP address of the external source and a file name of the printing data transmitted from the external source.

14. The printing system of claim 13, wherein the printing device outputs the signal to the external source using the IP address of the information.

15. The printing system of claim 5, wherein the printing device comprises a manipulation panel to input a request signal to re-execute a printing job of printing the printing data, so that the printing device outputs the signal to the external source.

16. The printing system of claim 15, wherein the request signal comprises a command signal to re-print the printed printing data, and the printing device prints the re-transmitted printing data upon receiving the same according to the request signal.

17. The printing system of claim 5, wherein the printing device comprises a manipulation panel to display the information and to provide a selection of the printing data to be re-printed according to the displayed information.

18. The printing system of claim 5, wherein the printing device comprises a printer having an engine control unit to execute a printing job of the transmitted printing data and a second printing job of the retransmitted printing data, and the external source comprises a personal computer connected to the printer.

19. A printing system comprising:
a computer to transmit printing data to an external printing device, to store information about the printing data and the external printing device, to receive from the external printing device a signal to re-transmit the transmitted printing data, and to re-transmit the printing data to the external printing device according to the signal and the information.

20. The printing system of claim 19, wherein the computer transmits second printing data to the external printing device, to store the information about the second printing data and the external printing device, to receive from the external printing device a second signal to re-transmit the transmitted second printing data, and to re-transmit the second printing data to the external printing device according to the second signal and the information.

21. The printing system of claim 19, wherein the computer transmits second printing data to a second external printing device, to store the information about the second printing data and the second printing device, to receive from the second external printing device a second signal to re-transmit the transmitted second printing data, and to re-transmit the second printing data to the second external printing device according to the second signal and the information.

22. The printing system of claim 19, wherein the computer automatically re-transmit the printing data to the external printing device upon receiving the signal.

23. The printing system of claim 19, wherein the transmitted printing data is identical to the re-transmitted printing data.

24. The printing system comprising:
an external source to generate printing data; and
a printing device to receive printing data transmitted from the external source, to print the printing data, to store information about the printing data and the external source, and to output a signal to request the external source to re-transmit the printing data, according to the information,
wherein the external source re-transmits the printing data to the printing device according to the signal of the printing device.

25. A printing method comprising:
printing data received from a host device in response to a request of the host device in a printing device;
storing in a memory information about the executed printing job and generating a list of the printing job information;
requesting re-execution of the printing job;
requesting the host device to re-transmit the printing data which was once printed, based on the information about the printing job; and
receiving the re-transmitted printing data from the host device to print the re-transmitted data.

26. The printing method of claim 25, wherein the requesting of the re-execution of the printing job comprises:
displaying a list including the information about the printing job; and
selecting the information about the printing job from the list.

27. The printing method of claim 25, wherein the information about the printing job comprises at least one of a printing job ID, a host ID, and a file name of the printing data.

28. The printing method of claim 25, further comprising:
re-transmitting the printing data from the host device to the printing device in response to the request for the re-transmission of the transmitted printing data.

29. The printing method of claim 25, further comprising:
storing the information in the host device; and
re-transmitting the printing data from the host device to the printing device according to the information and the request for the re-transmission of the transmitted printing data.
